(19) United States
(12) Patent Application Publication
(10) Pub. No.: US 2024/0268435 A1
(43) Pub. Date: Aug. 15, 2024

(54) DEVICE FOR ROASTING COFFEE BEAN

(71) Applicant: HUGH Inc., Chuncheon-si (KR)

(72) Inventor: Hyunsoo KIM, Paju-si (KR)

(21) Appl. No.: 18/173,921

(22) Filed: Feb. 24, 2023

(30) Foreign Application Priority Data
Feb. 14, 2023 (KR) 10-2023-0019244

(51) Int. Cl. A23N 12/08

(52) U.S. Cl. CPC A23N 12/08

(57) ABSTRACT

Disclosed herein is a device for roasting coffee beans. The device for roasting coffee beans includes: a driving body configured such that a motor-driven fan and electric control devices are installed therein; a roasting part mounted over the driving body, and configured to roast coffee beans using the flow of heated air; and a lid part mounted over the roasting part, and configured to receive coffee beans. The roasting part includes upper and lower containers, an air circulation tube, a heater unit, a turbo-fan, and a heated air guide plate. The device further includes a double heat-resistant container. The double heat-resistant container is formed in a double structure including an outer glass and an inner glass, and a space for maintaining a predetermined interval is provided between the outer glass and the inner glass.

### CROSS-REFERENCE TO RELATED APPLICATION

This application claims the benefit of Korean Patent Application No. 10-2023-0019244 filed on Feb. 14, 2023, which is hereby incorporated by reference herein in its entirety.

### BACKGROUND

### 1. Technical Field

The present invention relates to a device for roasting coffee beans. More specifically, the present invention relates to a device for roasting coffee beans using a heated air circulation method that is capable of maintaining an optimal roasting temperature.

### 2. Description of the Related Art

The process of roasting coffee beans is called roasting. Over the past decades, various types of devices for roasting coffee beans have been developed for use in homes and small cafes. Most of the known devices for roasting coffee beans adopt a method of heating coffee beans using heated air in their chamber. Coffee beans are heated uniformly by heated air while being mixed.

An important requirement for the devices for roasting coffee beans described above is to maintain the heating temperature, suitable for the condition and amount of coffee beans, for a fixed time. Furthermore, the devices for roasting coffee beans need to mix coffee beans evenly during roasting time so that uniform heat can be applied to the coffee beans. Moreover, in order to use the devices for roasting coffee beans in homes or small cafes, it is necessary to effectively separate husks from beans while roasting coffee beans in order to minimize the smoke generated during roasting.

The applicant of the present invention invented a device for roasting coffee beans that satisfies some of the above-described requirements for desired devices for roasting coffee beans, applied it for a patent, and was granted Korean patent No. 10-2381561 entitled “Device for Roasting Coffee Beans Using Hot Wind.”

The device for roasting coffee beans disclosed in the above patent is configured to suck the air, heated by the heater, into a turbo-fan and blow it into a space where coffee beans are accommodated.

The heated air blown into the coffee bean accommodation space is supplied back to the heater, and thus heated air is circulated.

FIG. 10 is a perspective view of the device for roasting coffee beans disclosed in the above patent, and FIG. 11 is a diagram illustrating the combination of a turbo-fan and a motor.

Referring to FIG. 10, the conventional device for roasting coffee beans: includes a body part 100; a volume part 200 coupled to the top of the body part 100 and provided with a space for accommodating coffee beans therein; and a cover part 300 provided to close the top of the volume part 200. The motor 110 is installed in the body part 100. The volume part 200 is installed with a pipe-shaped intake pipe 220, a heating module 221 installed inside the intake pipe 220, and a turbo-fan 210.

Referring to FIG. 11, the turbo-fan 210 includes an impeller 210a and a casing 210b. The impeller 210a is a semi-open impeller with wings on only one side thereof. On one side of the casing 210b, a through hole in communication with the lower end portion 220b of the intake pipe 220 is formed, and a plurality of discharge holes 213 for discharging the heated air sucked by the impeller 210a are formed. The discharge holes 213 are elongated holes that are long in their radial direction. The impeller 210a is connected to the motor 110, and is configured to receive the rotating force of the motor 110 and be then rotated. Coffee beans are placed in the casing 210b of the turbo-fan 210, and are roasted by the heated air discharged from the discharge holes 213.

### SUMMARY

The conventional device for roasting coffee beans having the above configuration is configured such that heated air is circulated, so that a rapid temperature rise to a uniform set temperature can be achieved and a uniform temperature distribution can also be achieved inside a roasting space. However, there is a problem in that the coffee beans placed and roasted in the casing of the turbo-fan are not uniformly mixed during roasting. That is, there is a problem in that coffee beans are only rotated and not mixed in the same position by the heated air supplied by the turbo-fan. Therefore, there is a problem in that coffee beans are not uniformly roasted. In addition, there is also a problem in that smoke is generated while the husks of coffee beans are circulated together with circulating heated air.

An object of the present invention is to overcome the above problems of the conventional device for roasting coffee beans. An object of the present invention is to provide a novel device for roasting coffee beans having a structure capable of uniformly mixing the coffee beans that are placed in the casing of a turbo-fan and roasted by heated air.

In addition, an object of the present invention is to provide a device for roasting coffee beans having a structure capable of reducing the generation of smoke by separating the husks of coffee beans during roasting.

In order to accomplish at least any one of the above objects, the present invention provides a device for roasting coffee beans, the device including: a driving body configured such that a motor-driven fan and electric control devices are installed therein; a roasting part mounted over the driving body, and configured to roast coffee beans using the flow of heated air; and a lid part mounted over the roasting part, and configured to receive coffee beans; wherein the roasting part includes: upper and lower containers configured to be assembled together to be superimposed on each other; an air circulation tube installed on the central side of the inside of the upper and lower containers; a heater unit installed inside the air circulation tube; a turbo-fan installed on the lower side of the inside of the lower container; and a heated air guide plate coupled to communicate with the air circulation tube while closing the bottom of the upper container, and configured to discharge air, heated by the heater unit, into a roasting space through a plurality of heated air outlets; wherein the device further includes a double heat-resistant container provided to surround the outside of the roasting part between the driving body and the lid part; and wherein the double heat-resistant container is formed in a double structure including an outer glass and an inner glass, and a space for maintaining a predetermined interval is provided between the outer glass and the inner glass so that the heat loss of coffee beans roasted inside the inner glass can be minimized.

The driving body may include a case, a motor installed inside the case, and a basket mounted on one side of the case and configured to discharge roasted beans; and the basket may be formed in a container shape in which a handle is formed on one side thereof and an inlet configured such that coffee beans are put thereinto is formed on an opposite side thereof.

A passage configured such that roasted beans fall into the basket therethrough may be formed inside the case.

The turbo-fan may include an impeller provided with blades and a casing configured to accommodate the impeller; and the casing may include upper and lower casings, the upper casing may be mounted on the air circulation tube, the lower casing may be mounted on the driving body, and the impeller may be rotatably mounted inside the casing, be connected to the motor of the driving body through the lower casing, and receive a rotational force of the motor and be then rotated thereby.

The lid part may include a cover mounted over the double heat-resistant container, a hot air outlet mounted in a hole formed in a top of the cover, and a bean input opening/closing opening installed on a front side of the cover to be selectively opened and closed and configured to receive coffee beans; and the lid part may further include a support disposed inside the cover and mounted on the top of the air circulation tube, and a bean husk filter mounted inside the support and configured to collect roasted bean waste.

The roasting part may be configured such that a coffee bean outlet is formed on one side of the upper container, hinge pieces are formed on left and right sides on the inner side of the coffee bean outlet, and a hinge rotation plate is installed on the hinge pieces.

One end of a guard operation part connected and installed in a ring shape and configured to automatically and selectively open and close the hinge rotation plate may be installed on one side of the hinge rotation plate and the opposite end of the guard operation part may include an automatic opening/closing device installed with a limit switch and a built-in motor, so that, after coffee beans have been roasted in the roasting part, the guard operation part is operated to be tilted by driving of the built-in motor by means of the limit switch so that the hinge rotation plate can be operated to be automatically and selectively opened and closed forward or rearward on the hinge pieces.

The device for roasting coffee beans according to the present invention has a structure capable of evenly mixing coffee beans while roasting them with heated air. That is, the device for roasting coffee beans includes the plurality of heated air outlets that communicate to discharge heated air into the roasting space of the bean container, and the plurality of heated air outlets non-uniformly supply heated air into the roasting space of the bean container along the circumferential direction. Therefore, the heated air is non-uniformly discharged into the roasting space along the circumferential direction, and the coffee beans floated by the heated air are evenly mixed while being moved to the portion where the discharge pressure of the heated air is low (the part where the discharge pressure of the heated air is low), and at the same time, the coffee beans are roasted.

### BRIEF DESCRIPTION OF THE DRAWINGS

The above and other objects, features, and advantages of the present invention will be more clearly understood from the following detailed description taken in conjunction with the accompanying drawings, in which:

FIGS. 1 to 6C show a device for roasting coffee beans according to the present invention, wherein:

FIG. 1 is a perspective view showing the overall front surface and rear surface of the device for roasting coffee beans according to the present invention;

FIG. 2 is an overall exploded perspective view of the device for roasting coffee beans according to the present invention;

FIG. 3 is an exploded bottom view showing the roasting part of the device for roasting coffee beans according to the present invention;

FIG. 4 is a plan view of the device for roasting coffee beans according to the present invention;

FIG. 5 is an exemplary cross-sectional view of FIG. 4 taken along line A-A; and

FIGS. 6A-6C are exemplary view showing the heated air guide plate of the roasting part, wherein FIG. 6A is a plan view of the heated air guide plate, FIG. 6B is a sectional view of the heated air guide plate, and FIG. 6C is a side view of the heated air guide plate;

FIG. 7 shows another embodiment of the roasting part of the device for roasting coffee beans according to the present invention;

FIG. 8 is an exemplary longitudinal cross-sectional view of FIG. 7;

FIG. 9 is a cross-sectional view showing, before and after operation, a state in which the roasting part of FIG. 7 is installed in the device for roasting coffee beans;

FIG. 10 is a perspective view of a conventional device for roasting coffee beans; and

FIG. 11 is a diagram illustrating a state in which the turbo-fan and motor of the conventional device for roasting coffee beans shown in FIG. 10 are combined with each other.

### DETAILED DESCRIPTION

The present invention may be subject to various modifications and have various embodiments. Specific embodiments will be illustrated in the drawings and described in the detailed description of the present invention. However, this is not intended to limit the present invention to the specific embodiments, and it should be understood that all modifications, equivalents, or substitutes included in the spirit and technical scope of the present invention are included in the scope of the present invention.

The present invention is not limited to the embodiments disclosed below and may be implemented in various different forms. Embodiments are provided merely to complete the disclosure of the present invention and to fully inform those of ordinary skill in the art of the scope of the invention.

Hereinafter, embodiments of the present invention will be described in detail with reference to the accompanying drawings. First, in the assignment of reference numerals to components of each drawing, it should be noted that the same components have the same numerals as much as possible even when they are illustrated in different drawings. In addition, in the description of the present invention, when it is determined that a detailed description of a related known configuration or function may obscure the gist of the present invention, the detailed description will be omitted.

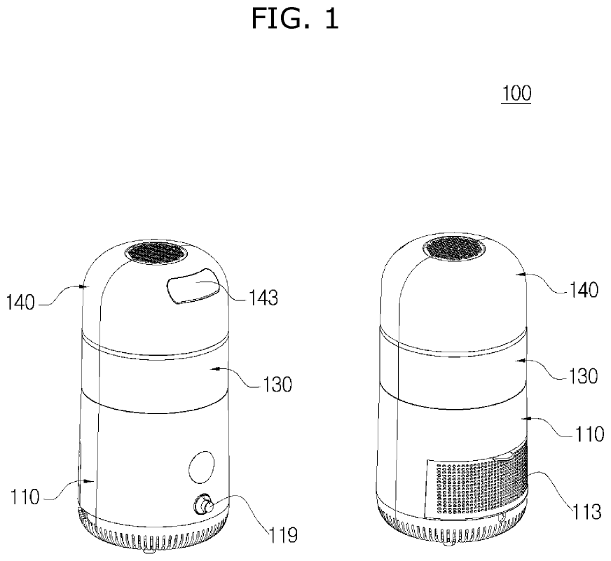

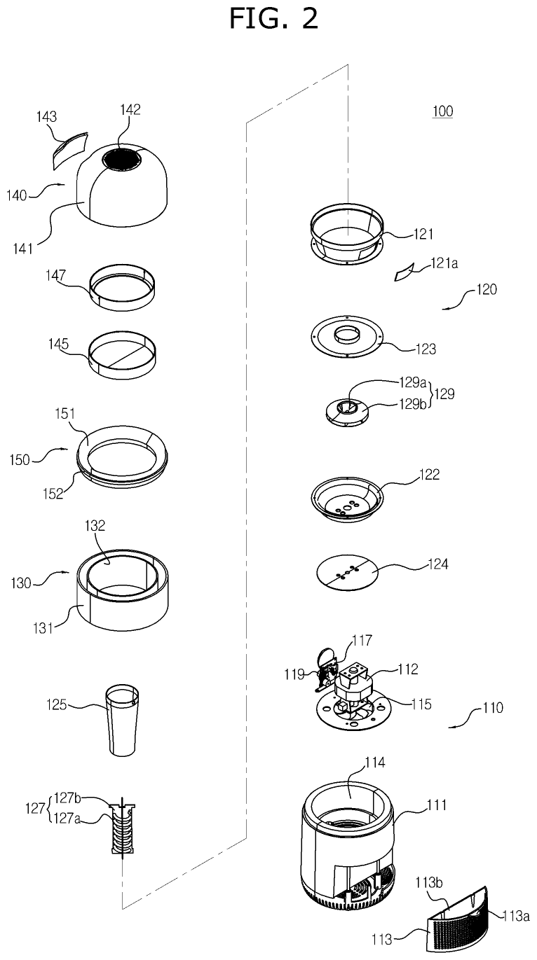

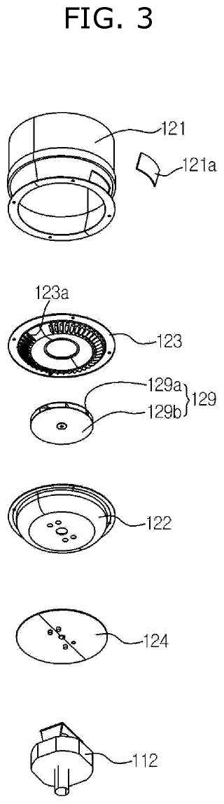

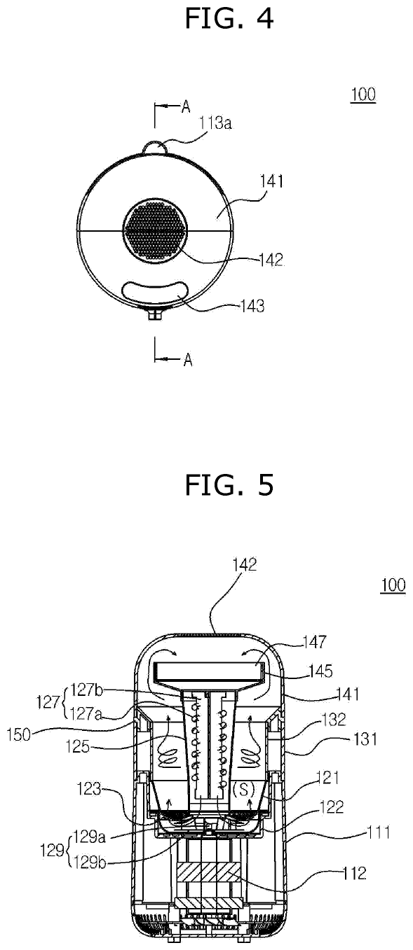

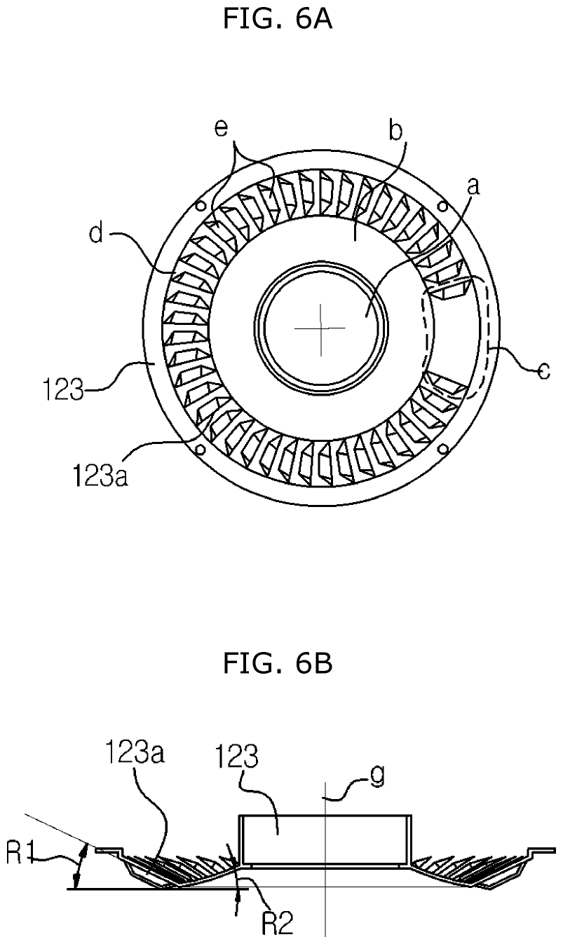

FIGS. 1 to 6C show a device for roasting coffee beans according to an embodiment of the present invention.

Referring to FIGS. 1 to 6C, the device 100 for roasting coffee beans according to the present invention includes: a driving body 110 configured such that a motor-driven fan and electric control devices are installed therein; a roasting part 120 mounted over the driving body 110, and configured to roast coffee beans using the flow of heated air; a double heat-resistant container 130 provided to surround the outside of the roasting part 120; a lid part 140 mounted over the roasting part 120, and configured to receive coffee beans; and a connection flange part 150 mounted between the double heat-resistant container 130 and the lid part 140 to connect them.

The driving body 110 includes a case 111, and a motor 112 installed inside the case 111. Furthermore, a basket 113 configured to discharge roasted beans is mounted on one side of the case 111. Furthermore, the basket 113 is formed in a container shape in which a handle 113a is formed on one side thereof and an inlet 113b configured such that coffee beans are put thereinto is s formed on the other side thereof. Meanwhile, a passage 114 configured such that roasted beans fall into the basket 113 therethrough is formed inside the case 111. Moreover, a fan 115 connected to the motor 112 and a PCB board 117 configured to perform electrical switch control are mounted. In addition, an operating switch 119 configured to control temperature, time, and electricity is installed to protrude out of the driving body 11 connected to the PCB board 117.

The roasting part 120 includes: upper and lower containers 121 and 122 configured to be assembled together to be superimposed on each other; an air circulation tube 125 installed on the central side of the inside of the upper and lower containers 121 and 122; a heater unit 127 installed inside the air circulation tube 125; and a turbo-fan 129 installed on the lower side of the inside of the lower container 122.

In addition, an opening/closing cover 121a configured to discharge roasted beans through an opening is installed on one side of the upper container 121.

In addition, there is mounted a heated air guide plate 123 coupled to communicate with the air circulation tube 125 while closing the bottom of the upper container 121 and configured to discharge the air, heated by the heater unit 127, into a roasting space through a plurality of heated air outlets 123a.

In addition, a fixing plate 124 mounted to fix the motor 112 of the driving body 110 is installed on the lower side of the lower container 122.

In addition, the heater unit 127 includes an electric heater 127a wound in a coil shape and a coil support 127b.

In addition, the turbo-fan 129 includes an impeller 129a provided with blades and a casing 129b configured to accommodate the impeller 129a. In this case, the casing 129b includes upper and lower casings, the upper casing is mounted on the air circulation tube 125, the lower casing is mounted on the driving body 110, and the impeller 129a is rotatably mounted inside the casing 129b. In addition, the impeller 129a is connected to the motor 112 of the driving body 110 through the lower casing, and is configured to receive the rotational force of the motor 112 and be then rotated thereby.

The double heat-resistant container 130 may be formed of a transparent material, e.g., a double glass, so that roasted beans can be observed in a state in which the double heat-resistant container 130 is mounted on the upper container 121 of the roasting part 120. In this case, the double glass includes an outer glass 131 and an inner glass 132, and a space capable of maintaining a predetermined interval is provided between the outer glass 131 and the inner glass 132, so that the heat loss of beans roasted inside the inner glass can be minimized.

The lid part 140 includes: a cover 141 mounted over the double heat-resistant container 130; a hot air outlet 142 mounted in a hole formed in the top of the cover 141; and a bean input opening/closing opening 143 installed on the front side of the cover to be selectively opened and closed and configured to receive coffee beans.

The lid part 140 further includes: a support 145 disposed inside the cover 141 and mounted on the top of the air circulation tube 125; and a bean husk filter 147 mounted inside the support 145 and configured to collect roasted bean waste. In this case, the support 145 has a stepped hollow pipe shape.

Meanwhile, the connection flange part 150 is installed between the lid part 140 and the double heat-resistant container 130 and closes the gap therebetween. In this case, a somewhat inclined surface 151 is formed on the top of the body of the connection flange part 150 is formed and a protruding edge 152 is formed along the center of the body, so that the gap between the lid part 140 and the double heat-resistant container 130 is closed by the connection flange part 150. In this case, it is installed to guide the coffee beans moved upward through the inclined surface to rapidly fall downward.

Preferably, a temperature sensor (not shown) configured to measure temperature is mounted on the air circulation tube 125. The control unit is configured to measure the temperature of the temperature sensor and control current to be supplied to the electric heater 127a in order to heat air to a set temperature. In addition, the control unit includes a communication unit configured to communicate with an external device such as a mobile phone. The control unit may be configured to adjust the temperature and time at and for which coffee beans are heated according to a roasting recipe received through an external device.

Meanwhile, the roasting space S may be defined by the inner wall of the upper container 121 of the roasting part 120, the outer wall of the air circulation tube 125, and the inner glass 132 of the double heat-resistant container 130.

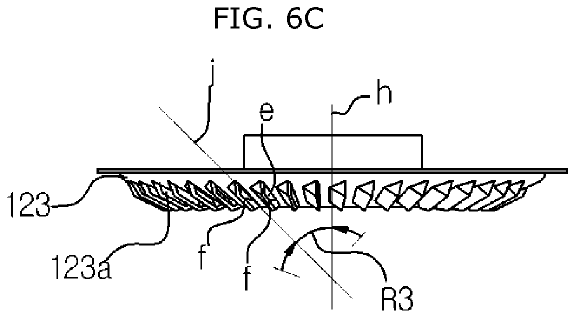

FIGS. 6A-6C exemplary views showing the heated air guide plate of the roasting part 120, wherein FIG. 6A is a plan view of the heated air guide plate 123, FIG. 6B is a sectional view of the heated air guide plate 123, and FIG. 6C is a side view of the heated air guide plate 123.

Referring to FIG. 6A, the heated air guide plate 123 has a disk shape, and is configured such that a heated air inlet “a” is formed in the center thereof and an impeller lid part “b” configured to cover the top of the impeller 129a is formed to extend radially from the heated air inlet “a.” In addition, a heated air outlet portion 123a is formed along the circumference of the heated air guide plate 123. The heated air outlet portion 123a includes a regularly arranged portion “d” in which heated air outlets “e” are disposed at regular intervals along the circumferential direction and a non-uniformly arranged portion “c” in which heated air outlets are disposed at different intervals along the circumferential direction.

Referring to FIG. 6B, the heated air outlet portion “c” and “d” is inclined at an angle R1 toward the central axis “g” of the air circulation tube 125, and the individual heated air outlets “e” are also inclined toward the central axis “g” of the air circulation tube 125. That is, the individual heated air outlets “e” are formed to face an inclined direction toward the central axis (g) of the air circulation tube 125, and the heated air discharged through the individual heated air outlets “e” is discharged toward the air circulation tube 125. In addition, the impeller lid part “b” of the heated air guide plate “123” is inclined at a predetermined angle R2 toward the outside with respect to the central axis “g” of the air circulation tube 125.

Referring to FIGS. 6A and 6C, the heated air outlets “e” each have an elongated hole shape that is long in the radial direction. Furthermore, the heated air outlets “e” are formed along a plane “I” inclined at an angle R3 with respect to a plane “h” including the central axis “g” of the air circulation tube 125. Accordingly, the heated air discharged through the heated air outlets “e” is discharged in the circumferential direction of the heated air guide plate 123. In addition, guides “f” configured to guide the flow of heated air are formed on the lower surfaces of the heated air outlets “e”. The individual guides “f” are disposed in the same direction as the corresponding heated air outlets “e” and guide the flow of the heated air in desired directions.

As described with reference to FIGS. 6A-6C, the plurality of heated air outlets “e” non-uniformly supply heated air to the roasting space S of the bean container along the circumferential direction of the heated air guide plate 123. When beans are roasted, the beans are placed on the upper heated air guide plate 123 of the turbo-fan 129, and are floated and roasted by the heated air discharged to the individual heated air outlets “e” of the heated air guide plate 123. In this case, the heated air outlets “e” non-uniformly discharge the heated air to the roasting space of the bean container along the circumferential direction of the heated air guide plate 123. Accordingly, the coffee beans floated to the top of the heated air guide plate 123 by the pressure of the heated air are moved to a portion where the discharge pressure of the heated air is low (a portion where the discharge pressure of the heated air is low). When passing through a portion where floating force is uneven during movement, beans in the top, bottom, left and right are evenly mixed and roasted.

The operation and effects of the device for roasting coffee beans according to the present invention will be described below. The following description is based on the above structural description.

First, when the impeller 129a is rotated by the rotation of the motor 112, the air heated by the electric heater 127a inside the air circulation tube 125 is sucked into the casing 129b through the opening in the top of the casing 129b.

Next, the heated air sucked into the casing 129b passes through the plurality of heated air outlets 123a of the heated air guide plate 123 and is supplied to the roasting space S.

In addition, the heated air supplied to the roasting space S floats the coffee beans placed on the inner glass 132 of the double heat-resistant container 130, and the floated coffee beans are moved in the circumferential direction while being roasted, and at the same time, the floated coffee beans are evenly mixed while changing their top or bottom positions. The heated air having passed through the coffee beans passes through the space inside the upper portion of the upper container 121 of the roasting part 120 and the cover 141 of the lid part 140 and the bean husk filter 147, is sucked into the upper part of the air circulation tube 125, and is then circulated. In the case where coffee beans are roasted, when the husks of the beans are separated and circulated along with the circulating heated air, smoke may be generated by the electric heater 127a. The bean husk filter 147 installed above the air circulation tube 125 prevents smoke from being generated during roasting by filtering the husks of coffee beans.

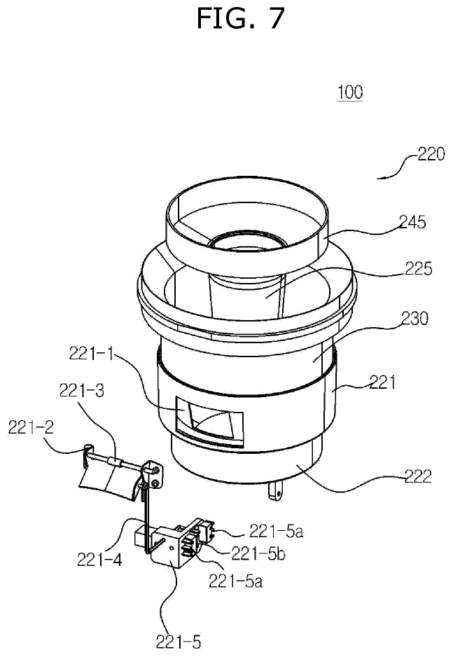

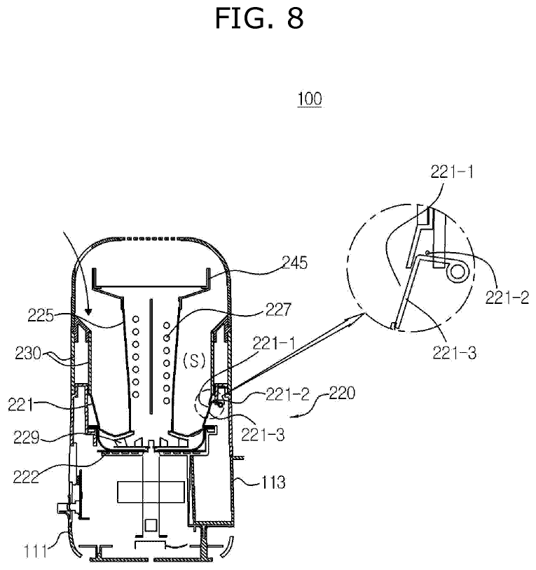

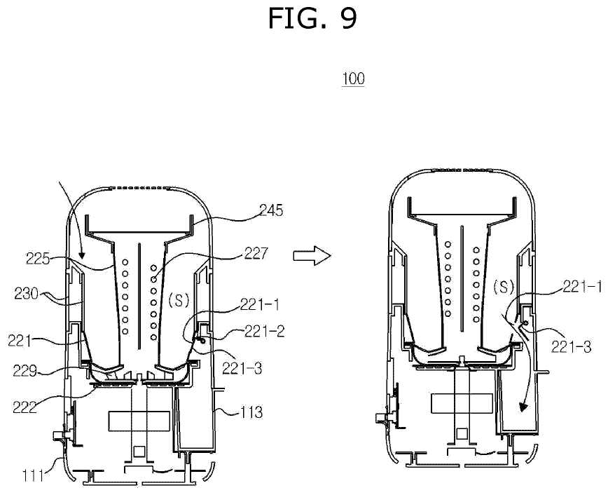

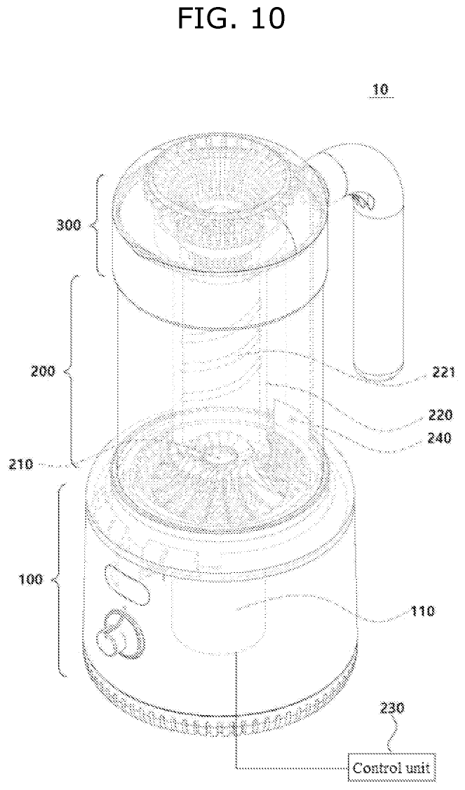

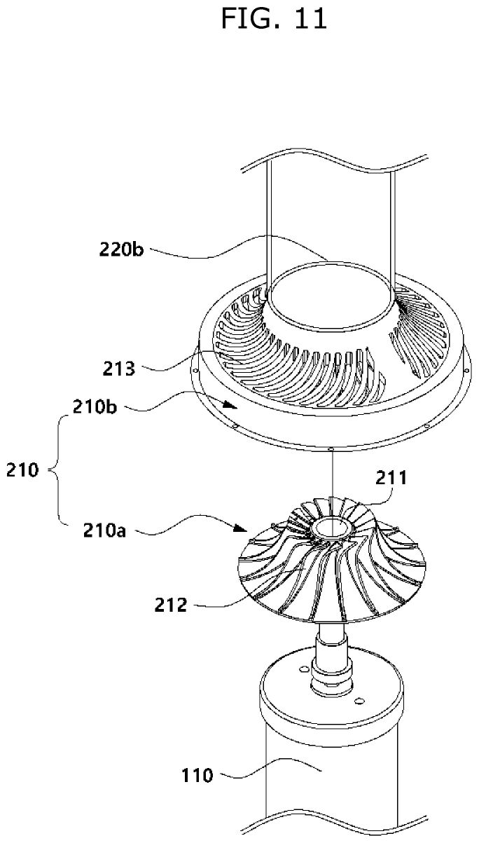

Meanwhile, FIG. 7 shows another embodiment of the roasting part of the device for roasting coffee beans according to the present invention, FIG. 8 is a longitudinal cross-sectional view of FIG. 7, and FIG. 9 is a cross-sectional view showing, before and after operation, a state in which the roasting part of FIG. 7 is installed in the device for roasting coffee beans.

Referring to FIGS. 7 to 9, the roasting part 220 includes: upper and lower containers 221 and 222 configured to be assembled to be superimposed on each other; an air circulation tube 225 installed on the central side of the inside of the upper and lower containers 221 and 222; a heater unit 227 configured such that the air circulation tube 225 is installed therein; and a turbo-fan 229 installed on the lower side of the inside of the lower container 222. In addition, a support 245 mounted at the top of the air circulation tube 225 may be installed.

In the roasting part 220, a coffee bean outlet 221-1 may be formed on one side of the upper container 221, hinge pieces 221-2 may be formed on left and right sides on the inner side of the coffee bean outlet 221-1, and hinge rotation plates 221-3 may be installed on the hinge piece 221-2.

One end of a guard operation part 221-4 connected and installed in a ring shape and configured to automatically and selectively open and close the hinge rotation plate may be installed on one side of the hinge rotation plate 221-3, and the other end of the guard operation part 221-4 may include an automatic opening/closing device 221-5 installed with a limit switch 221-5a and a built-in motor 221-5b. Accordingly, after coffee beans have been roasted in the roasting part, the guard operation part 221-4 may be operated to be tilted by the driving of the built-in motor 221-5b by means of the limit switch 221-5a so that the hinge rotation plate 221-3 can be operated to be automatically and selectively opened and closed forward or rearward on the hinge pieces 221-2.

As described above, the device for roasting coffee beans according to the present invention includes the plurality of heated air outlets that communicates to discharge heated air into the roasting space of the bean container, and the plurality of heated air outlets are configured to non-uniformly supply heated air to the roasting space of the bean container along the circumferential direction. Accordingly, the heated air is discharged unevenly into the roasting space along the circumferential direction, and the coffee beans floated by the heated air are mixed evenly while being moved to the portion where the smaller amount of heated air is discharged (the portion where the discharge pressure of the heated air is lower) and, and at the same time, roasting is also performed.

While the present invention has been shown and described using example embodiments above, it is not limited to the above embodiments. It is obvious that various modifications and alteration may be made based on the spirit of the present invention and the attached claims by those of ordinary skill in the art to which the present invention pertains within the scope of the spirit of the present invention.

What is claimed is:

1. A device for roasting coffee beans, the device comprising: a driving body configured such that a motor-driven fan and electric control devices are installed therein; a roasting part mounted over the driving body, and configured to roast coffee beans using a flow of heated air; and a lid part mounted over the roasting part, and configured to receive coffee beans;
wherein the roasting part includes: upper and lower containers configured to be assembled together to be superimposed on each other; an air circulation tube installed on a central side of an inside of the upper and lower containers; a heater unit installed inside the air circulation tube; a turbo-fan installed on a lower side of an inside of the lower container; and a heated air guide plate coupled to communicate with the air circulation tube while closing a bottom of the upper container, and configured to discharge air, heated by the heater unit, into a roasting space through a plurality of heated air outlets;
wherein the device further comprises a double heat-resistant container provided to surround an outside of the roasting part between the driving body and the lid part; and
wherein the double heat-resistant container is formed in a double structure including an outer glass and an inner glass, and a space for maintaining a predetermined interval is provided between the outer glass and the inner glass so that a heat loss of coffee beans roasted inside the inner glass can be minimized.

2. The device of claim 1, wherein:
the driving body includes a case, a motor installed inside the case, and a basket mounted on one side of the case and configured to discharge roasted beans; and
the basket is formed in a container shape in which a handle is formed on one side thereof and an inlet configured such that coffee beans are put thereinto is formed on an opposite side thereof.

3. The device of claim 2, wherein a passage configured such that roasted beans fall into the basket therethrough is formed inside the case.

4. The device of claim 1, wherein:
the turbo-fan includes an impeller provided with blades and a casing configured to accommodate the impeller; and
the casing includes upper and lower casings, the upper casing is mounted on the air circulation tube, the lower casing is mounted on the driving body, and the impeller is rotatably mounted inside the casing, is connected to the motor of the driving body through the lower casing, and receives a rotational force of the motor and is then rotated thereby.

5. The device of claim 1, wherein:
the lid part includes:
a cover mounted over the double heat-resistant container;
a hot air outlet mounted in a hole formed in a top of the cover; and
a bean input opening/closing opening installed on a front side of the cover to be selectively opened and closed, and configured to receive coffee beans; and
the lid part further includes:
a support disposed inside the cover, and mounted on a top of the air circulation tube; and
a bean husk filter mounted inside the support, and
configured to collect roasted bean waste.

6. The device of claim 1, wherein the roasting part is configured such that a coffee bean outlet is formed on one side of the upper container, hinge pieces are formed on left and right sides on an inner side of the coffee bean outlet, and a hinge rotation plate is installed on the hinge pieces.

7. The device of claim 6, wherein:
one end of a guard operation part connected and installed in a ring shape and configured to automatically and selectively open and close the hinge rotation plate is installed on one side of the hinge rotation plate, and an opposite end of the guard operation part includes an automatic opening/closing device installed with a limit switch and a built-in motor, so that:
after coffee beans have been roasted in the roasting part, the guard operation part is operated to be tilted by driving of the built-in motor by means of the limit switch so that the hinge rotation plate can be operated to be automatically and selectively opened and closed forward or rearward on the hinge pieces.
